(19) United States
(12) Patent Application Publication
(10) Pub. No.: US 2009/0222280 A1
(43) Pub. Date: Sep. 3, 2009

(54) System and method for certification data management

(76) Inventors: Shiva Mittal, Peoria, IL (US); Srinivas Nimmagadda, Peoria, IL (US); Keith Robert Glascock, Peoria, IL (US); Shelly Renee Frazier, Chillicothe, IL (US); Bradley Todd Ford, Wylie, TX (US)

Correspondence Address: CATERPILLAR/FINNEGAN, HENDERSON, L.L.P., 901 New York Avenue, NW, WASHINGTON, DC, 20001-4413, US

(21) Appl. No.: 12/073,131

(22) Filed: Feb. 29, 2008

(51) Int. Cl. G06Q 10/00

(52) U.S. Cl. 705/1

(57) ABSTRACT

A system and method are disclosed that provide for processing certification data. The system and method include determining a rating definition associated with an engine configuration, and associating an arrangement number with the rating definition. In addition, the system and method include associating a certification type with the arrangement number, and associating a certification dataset, created by recording emissions test results of one or more emissions data parameters, with the rating definition to generate a certification family. The one or more emissions data parameters are included in at least one of an emissions law or an emissions regulation.

### TECHNICAL FIELD

The present disclosure relates generally to a system and method for managing data, and more particularly, to a system and method for automated management of certification data.

### BACKGROUND

Regulatory compliance may refer to systems and/or methods adopted to ensure compliance with relevant laws and regulations. Because relevant laws and regulations may cover many types of business activities, businesses may require a significant amount of resources to ensure compliance with those laws and regulations that impact their own business activities. The types of business activities impacted by regulatory compliance requirements may include, for example, financial disclosure and reporting, data protection, chemical handling, sale, and transportation, food handling, emissions, etc.

Regulatory compliance may require complex data collection, tracking, and reporting because of the variety of laws and regulations even within a single industry. That is, the relevant laws and regulations may vary from region to region, state to state, country to country, continent to continent, as well as from application to application, industry to industry, etc. As an example, emissions laws and regulations may be implemented and/or enforced by states (e.g., California Air Resources Board, Texas Department of Public Safety, etc.), countries (e.g., U.S. Environmental Protection Agency, Canadian Environmental Assessment Agency, etc.), continents (e.g., European Environment Agency, etc.), or any combination thereof. Emissions laws and regulations may also vary based on the type of application. For example, a marine-based application may be required to meet laws and regulations which are different than those of a power generating application or a land-based transportation application.

Systems and methods have been created for facilitating compliance with governmental regulations. One such example is disclosed in U.S. Patent Application Publication Number 2003/0131011 (the '011 application) to Haunschild et al., published on Jul. 10, 2003. The '011 publication discloses a plurality of secured databases including governmental regulations, industry standards, and company policies requiring compliance by client users. In the '011 publication, a database engine generates compliance data for identified subject items. The compliance data includes regulatory compliance data for subject items input by a user and applicable compliance requirements. In addition, the compliance data includes required actions, compliance triggers necessary to fulfill compliance requirements, and the identification of a responsible person for performing the required action.

Although the system and method of the '011 publication may be capable of facilitating compliance with government regulations, the system and method do not offer a way to automatically prepare documents for certification with regulatory bodies. In addition, the system and method of the '011 publication do not provide a way to identify one or more expiring certifications and/or update the one or more expiring certifications. Nor does the system and method of the '011 publication automatically rollover non-expiring certifications from certification period to certification period. The system and method of the '011 publication is also unable to automatically update certification documents for multiple regulatory agencies. Thus, the system of the '011 publication may be inefficient and tedious.

The disclosed system is directed to overcoming one or more of the problems set forth above.

### SUMMARY OF THE INVENTION

In one aspect, the present disclosure is directed to a method for processing certification data. The method includes determining a rating definition associated with an engine configuration, and associating an arrangement number with the rating definition. In addition, the method includes associating a certification type with the arrangement number, and associating a certification dataset, created by recording emissions test results of one or more emissions data parameters, with the rating definition to generate a certification family. The one or more emissions data parameters are included in at least one of an emissions law or an emissions regulation.

In another aspect, the present disclosure is directed to a computer-readable medium including instructions for performing a method, when executed by a processor, for processing certification data. The method includes determining a rating definition associated with an engine configuration, and associating an arrangement number with the rating definition. In addition, the method includes associating a certification type with the arrangement number, and associating a certification dataset, created by recording emissions test results of one or more emissions data parameters, with the rating definition to generate a certification family. The one or more emissions data parameters are included in at least one of an emissions law or an emissions regulation.

In another aspect, the present disclosure is directed to a system for processing certification data. The system includes at least one memory storing data and instructions and at least one processor configured to access the memory and execute the instructions. The at least one processor is configured to determine a rating definition associated with an engine configuration, associate an arrangement number with the rating definition, and associate a certification type with the arrangement number. In addition, the at least one processor is configured to associate a certification dataset, created by recording emissions test results of one or more emissions data parameters, with the rating definition to generate a certification family. The at least one processor is also configured to associate one or more certification types with the certification family, and generate a certification family/certification type combination. Further, the at least one processor is configured to add one or more qualified ratings to the certification family/certification type combination, determine if the certification family/certification type combination includes one or more expiring certification types, and generate, when the certification family/certification type combination does not include one or more expiring certification types, a rollover certification family. The rollover certification family includes the certification family/certification type combination and the one or more qualified ratings. Additionally, the at least one processor is configured to associate one or more non-expiring certification types to all arrangements in the certification family/certification type combination which includes the one or more expiring certification types, and add, to one of the new certification family/certification type combination or an existing certification family/certification type combination, the one or more non-expiring certification types. Finally, the at least one processor is configured to generate one or more reports, and provide the one or more reports to one or more regulatory bodies. The one or more reports include at least one certification associated with the one or more regulatory bodies.

In another aspect, the present disclosure is directed to a method for processing certification data. The method includes generating a certification family, and associating one or more certification types with the certification family to generate a certification family/certification type combination. The method also includes adding one or more qualified ratings to the certification family/certification type combination, and determining if the certification family/certification type combination includes one or more expiring certification types. In addition, the method includes generating, when the certification family/certification type combination does not include one or more expiring certification types, a rollover certification family. The rollover certification family includes the certification family/certification type combination and associated rating definitions.

In another aspect, the present disclosure is directed to a computer-readable medium. The computer-readable medium includes instructions for performing a method, when executed by a processor, for processing certification data. The method includes generating a certification family, and associating one or more certification types with the certification family to generate a certification family/certification type combination. The method also includes adding one or more qualified ratings to the certification family/certification type combination, and determining if the certification family/certification type combination includes one or more expiring certification types. In addition, the method includes generating, when the certification family/certification type combination does not include one or more expiring certification types, a rollover certification family. The rollover certification family includes the certification family/certification type combination and associated rating definitions.

In another aspect, the present disclosure is directed to a system for processing certification data. The system includes at least one memory storing data and instructions, and at least one processor configured to access the memory and execute the instructions. The at least one processor is configured to generate a certification family, and associate one or more certification types with the certification family to generate a certification family/certification type combination. The at least one processor is further configured to add one or more qualified ratings to the certification family/certification type combination, and determine if the certification family/certification type combination includes one or more expiring certification types. In addition, the at least one processor is configured to generate, when the certification family/certification type combination does not include one or more expiring certification types, a rollover certification family. The rollover certification family includes the certification family/certification type combination and associated rating definitions.

### BRIEF DESCRIPTION OF THE DRAWINGS

FIG. 1 is a block diagram of an exemplary system architecture, consistent with certain disclosed embodiments;

FIG. 2 is a flow chart illustrating an exemplary process for generating data for certification data management, consistent with certain disclosed embodiments;

FIG. 3 is a screenshot of an exemplary rating definition, consistent with certain disclosed embodiments;

FIG. 4 is a flow chart illustrating an exemplary process for adding a certification type to a certification family, consistent with certain disclosed embodiments;

FIG. 5 is an exemplary data tree, consistent with certain disclosed embodiments;

FIG. 6 is a flow chart illustrating an exemplary process for processing certification families, consistent with certain disclosed embodiments; and

FIG. 7 is a flow chart illustrating an exemplary process for generating reports, consistent with certain disclosed embodiments.

### DETAILED DESCRIPTION

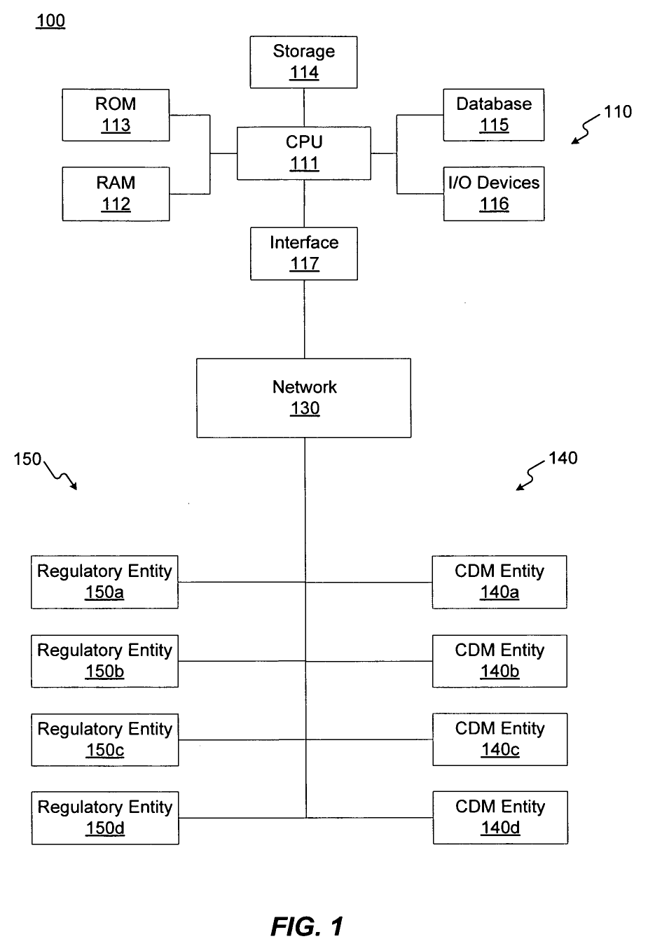

FIG. 1 illustrates an exemplary system architecture 100 in which principles and methods consistent with the disclosed embodiments may be implemented. As shown in FIG. 1, system architecture 100 may include one or more hardware and/or software components configured to collect, monitor, store, analyze, evaluate, distribute, report, process, record, and/or sort information associated with automated processing of certification data. For example, system architecture 100 may include Certification Data Management (CDM) computing system 110, network 130, a plurality of CDM entities 140, and a plurality of regulatory entities 150.

CDM computing system 110 may include one or more hardware and/or software components such as, for example, central processing unit (CPU) 111, random access memory (RAM) module 112, read-only memory (ROM) module 113, storage 114, database 115, one or more input/output (I/O) devices 116, and interface 117. CDM computing system 110 may be configured to receive, collect, analyze, evaluate, report, display, and distribute data related to the automated processing of certification data, and may use one or more software components or applications. For example, CDM computing system 110 may be configured to manage and track regulatory requirements, emission test data, engine configuration information, parts information for a plurality of parts, information regarding system software, and the like, associated with the management, tracking, and collection of emission data, and perform automated processing of certification data. CDM computing system 110 may be, for example, a server, a desktop, a laptop, and the like.

CPU 111 may include one or more processors, each configured to execute instructions and process data to perform functions associated with CDM computing system 110. As illustrated in FIG. 1, CPU 111 may be connected to RAM 112, ROM 113, storage 114, database 115, I/O devices 116, and interface 117. CPU 111 may be configured to execute computer program instructions to perform various processes and methods consistent with certain disclosed embodiments. The computer program instructions may be loaded into RAM 112 for execution by CPU 111.

RAM 112 and ROM 113 may each include one or more devices for storing information associated with operation of CDM computing system 110 and/or CPU 111. For example, ROM 113 may include a memory device configured to access and store information associated with CDM computing system 110, including information for identifying, initializing, and monitoring the operation of one or more components and/or subsystems of CDM computing system 110. RAM 112 may include a memory device for storing data associated with one or more operations performed by CPU 111. For example, instructions from ROM 113 may be loaded into RAM 112 for execution by CPU 111.

Storage 114 may include any type of storage device configured to store any type of information used by CPU 111 to perform one or more processes consistent with the disclosed embodiments. For example, storage 114 may include one or more magnetic and/or optical disk devices, such as hard drives, CD-ROMs, DVD-ROMs, or any other type of media storage device.

Database 115 may include one or more software and/or hardware components that store, organize, sort, filter, and/or arrange data used by CDM computing system 110 and/or CPU 111. Database 115 may include a relational, distributed, or any other suitable database format. A relational database may be in tabular form where data may be organized and accessed in various ways. A distributed database may be dispersed or replicated among different locations within a network. For example, database 115 may store information such as regulatory requirements, emission test data, engine configuration information, parts information, information regarding system software, and the like, associated with the management, tracking, and collection of emission data, or any other information that may be used by CPU 111 to perform automated processing of certification data. Database 115 may also include one or more analysis tools for analyzing information within the database. Database 115 may store additional and/or different information than that listed above.

I/O devices 116 may include one or more components configured to communicate information with a user associated with CDM computing system 110. For example, I/O devices 116 may include a console with an integrated keyboard and mouse to allow a user to input parameters associated with CDM computing system 110 and/or data associated with automated processing of certification data. I/O devices 116 may also include a user-accessible disk drive (e.g., a USB port, a floppy, CD-ROM, or DVD-ROM drive, etc.) to allow a user to input data stored on a portable media device. Additionally, I/O devices 116 may include one or more displays or other peripheral devices, such as, for example, a printer, a camera, a microphone, a speaker system, an electronic tablet, or any other suitable type of input/output device.

Interface 117 may include one or more components configured to transmit and receive data via network 130. In addition, interface 117 may include one or more modulators, demodulators, multiplexers, de-multiplexers, network communication devices, wireless devices, antennas, modems, and any other type of device configured to enable data communication via any suitable communication network. It is further anticipated that interface 117 may be configured to allow CPU 111, RAM 112, ROM 113, storage 114, database 115, and one or more I/O devices 116 to be located remotely from one another and perform automated processing of certification data.

CDM computing system 110 may include additional, fewer, and/or different components than those listed above and it is understood that the listed components are exemplary only and not intended to be limiting. For example, one or more of the hardware components listed above may be implemented using software. In one exemplary embodiment, storage 114 may include a software partition associated with one or more other hardware components of CDM computing system 110. Furthermore, additional hardware and/or software may also be required to operate CDM computing system 110, such as, for example, security applications, authentication systems, dedicated communication system, etc. The hardware and/or software may be interconnected and accessed as required by authorized users. In addition, a portion, or all of, CDM computing system 110 may be hosted and/or operated by a third party.

As discussed above, CDM computing system 110 may be in communication with network 130 by means of interface 117. Network 130 may be any appropriate communication network allowing communication between or among one or more entities. Network 130 may include, for example, the Internet, a local area network, a workstation peer-to-peer network, a direct link network, a wireless network, or any other suitable communication platform. Connection with network 130 may be wired, wireless, or any combination thereof.

CDM entities 140a, 140b, 140c, and 140d may each be connected to CDM computing system 110 through network 130. CDM entities 140 may be any individual or group associated with collecting, calculating, distributing, updating, viewing, certifying, or otherwise maintaining data and/or ensuring compliance with one or more regulations and/or laws. In addition, CDM entities 140 may include one or more individuals or groups responsible for oversight of compliance with one or more regulations and/or laws. CDM entities 140 may include, for example, one or more individuals or groups responsible for test engineering, product engineering, mechanical engineering, certification engineering, etc.

In one exemplary embodiment, the one or more regulations and/or laws may include emissions regulations and/or laws, and certification data may include emissions-related data. Emissions-related data may include any data associated with the collection, calculation, determination of emissions, emissions certification, etc. Emissions-related data may include, for example, parts data, software data, engine data, arrangement data, power data, speed data, particulate matter data, test data, emissions regulations, emissions regulation bodies, etc. Emissions regulations and/or laws may include regulations and/or laws related to any particulate or gaseous producing machine, such as, for example, engines, generators, trucks, etc. Emissions regulations and/or laws may also vary based on category or application. Categories may include, for example, off-road transportation, highway transportation, marine, power generation, etc, and the one or more regulations and/or laws may vary accordingly.

Regulatory entities 150a, 150b, 150c, and 150d may each be connected to CDM computing system 110 through network 130. Regulatory entities 150 may be any individual and/or group associated with determining, distributing, monitoring, validating, and/or ensuring compliance with one or more regulations and/or laws. In addition, regulatory entities 150 may include one or more individuals or groups responsible for oversight of compliance with one or more regulations and/or laws. In one exemplary embodiment, the one or more regulations and/or laws may be one or more emissions regulations and/or laws, and the regulatory entities 150 may include, for example, California Air Resources Board, U.S. Environmental Protection Agency, Canadian Environmental Assessment Agency, European Environment Agency, etc.

CDM entities 140 and regulatory entities 150 may each include one or more computing devices (i.e., desktop, laptop, mainframe, server, client, handheld computing device, personal digital assistant, telephony device, tablet PC, bar code reader, scanner, etc.) and various other hardware and/or software components (not shown). The one or more computing devices may allow CDM entities 140 and regulatory entities 150 to connect to and communicate with CDM computing system 110 by means of network 130. The connection between CDM entities 140 and network 130 and between regulatory entities 150 and network 130 may be through any combination of wired and/or wireless means.

In one exemplary embodiment, CDM computing system 110 may be owned, operated, and/or supported, either in whole or in part, by an engine manufacturer, and the engine manufacturer may utilize CDM computing system 110 to perform the method of the disclosed embodiments. An engine manufacturer may be, for example, any entity performing the task of designing, manufacturing, assembling, and/or distributing engines or other components which may be subject to regulation. Alternatively and/or additionally, CDM computing system 110 may be located in a facility or property owned, operated, and/or supported, either in whole or in part, by a parts distributor. CDM computing system 110 also may be owned, operated, and/or supported, either in whole or in part, by a certification computing entity, and CDM computing system 110 may receive, collect, store, analyze, evaluate, report, display and distribute data consistent with the certain disclosed embodiments. The certification computing entity may be, for example, a business or other organization configured to perform automated emissions certification on behalf of an engine manufacturer consistent with certain disclosed embodiments.

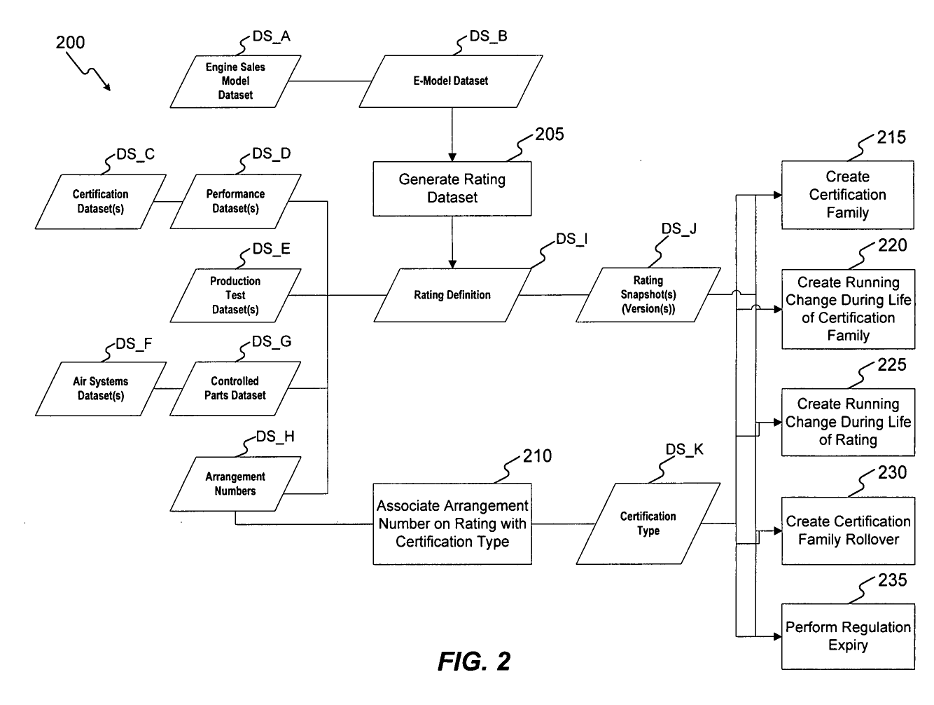

FIG. 2 illustrates a flowchart 200 of an exemplary process for determining a rating definition, rating snapshot, and certification type, consistent with certain disclosed embodiments. The process of FIG. 2 may be performed by CDM computing system 110. For example, CDM computing system 110 may execute one or more software programs that perform one or more of the process steps shown in FIG. 2.

CDM computing system 110 may access database 115 and determine data associated with one or more parameters to generate a rating dataset (step 205). The rating dataset may reflect a power configuration of an engine. For example, the rating dataset may include one or more parameters, such as, for example, advertised speed, advertised power, advertised torque, advertised torque speed, high idle speed, low idle speed, etc. The rating dataset may be generated using an engine sales model dataset DS_A and an e-model dataset DS_B. More than one rating dataset may be associated with each combination of engine sales model dataset DS_A and e-model dataset DS_B.

In one exemplary embodiment, to generate a rating dataset, CDM computing system 110 may access database 115 and determine data associated with one or more parameters to generate an engine sales model dataset DS_A. The engine sales model dataset DS_A may reflect data associated with an engine size, and may include one or more parameters, such as, for example, an engine sales model identifier, a machine sales model identifier, a number of cylinders, a combustion type (e.g., direct injection, spark-ignited, etc.), a fuel type (e.g., gas, diesel, etc.), an aspiration type (e.g., naturally-aspirated, turbo-charged/aftercooled, jacket water aftercooled, etc.), and the like. The generated engine sales dataset DS_A may be stored in database 115.

In addition, CDM computing system 110 may access database 115 and determine data associated with one or more parameters to generate an e-model dataset DS_B. The e-model dataset DS_B may reflect an engineering model number for an engine, and may include one or more parameters, such as, for example, a unique engineering model number, a unique design control number, bore value, stroke value, displacement per cylinder, displacement total, application (e.g., machine, generator, marine, etc.), application duty (e.g., heavy duty, medium duty, light duty, prime, etc.), etc. The generated e-model dataset DS_B may be stored in database 115.

A unique rating definition DS_I may be generated for each unique combination of engine sales model dataset DS_A, e-model dataset DS_B, and rating dataset. In one exemplary embodiment, CDM computing system 110 may also utilize advertised information in conjunction with the engine sales model dataset DS_A and e-model dataset DS_B to generate a unique rating definition DS_I. The unique rating definition DS_I may be stored in database 115.

In addition, each unique rating definition DS_I may be associated with one or more performance datasets DS_D, one or more production test datasets DS_E, one controlled parts dataset DS_G, and one or more arrangement numbers DS_H. The one or more performance datasets DS_D, one or more production test datasets DS_E, one controlled parts dataset DS_G, and one or more arrangement numbers DS_H may, for example, provide supporting data for the unique rating definition DS_I. Each of the one or more performance datasets DS_D, one or more production test datasets DS_E, one controlled parts dataset DS_G, and one or more arrangement numbers DS_H may be stored in database 115.

The one or more performance datasets DS_D may include data associated with the performance of an engine. For example, the one or more performance datasets DS_D may include full load data (e.g., certified engine power, certified engine speed, generator certified power, generator certified speed, measured fuel rate, calculated certified fuel rate, adjusted certified fuel rate, exhaust temperature, compressor outlet pressure, etc.), peak torque data (e.g., certified torque, certified torque speed, measured fuel rate, certified fuel rate, adjusted fuel rate, exhaust temperature, certified torque rise, torque at high idle, etc.), and the like.

Each performance dataset DS_D may, in turn, be associated with one or more certification datasets DS_C. The one or more certification datasets DS_C may include data associated with testing the emissions of an engine using one or more international standards specified test cycles. For example, the one or more certification datasets DS_C may include data associated with CO (carbon monoxide), HC (hydrocarbon), NOX (nitrous oxide), NOX+HC, PM (particulate matter), THC (total hydrocarbons)+NOX, etc.

The one or more production test datasets DS_E may include test data associated with a production model. For example, the one or more production test datasets DS_E may include data associated with a test specification part number (e.g., engineering model version, master specification part number, engine serial number prefix, replacement specification part number, reference specification serial number, revised specification value, specification type, facility code, etc.), full load data (e.g., engine test power, engine test speed, corrected specific fuel consumption, fuel rate, static fuel setting, electronic fuel setting, boost pressure, etc.), torque check data (e.g., run torque check, engine torque, engine torque speed, calculated torque rise percentage, static fuel setting, electrical fuel setting, fuel rate, boost pressure, etc.), and the like.

The controlled parts dataset DS_G may include data associated with one or more parts of the engine. For example, the controlled parts dataset DS_G may include data associated with the fuel systems (e.g., pump type, governor type, pump and/or governor number, mechanical advanced part number, injector type, fuel injector upper level part number, fuel injector part number, fuel nozzle or fuel valve part number, static timing value, timing advance value, etc.), combustion systems (e.g., piston type, piston part number, piston material, piston crown assembly part number, liner part number, cylinder head part number, camshaft part number, etc.), after-treatment systems (e.g., after-treatment type, after-treatment chart part number, after-treatment surface area, etc.), cooling systems (e.g., after-cooler core part number, after-cooler system mechanism, after-cooler system medium, etc.), and the like.

In addition, the controlled parts dataset DS_G may be associated with one or more air systems datasets DS_F. The one or more air systems datasets DS_F may include data associated with, for example, a number of turbo-chargers on an engine, turbo-charger type, turbo-charger pressure, turbo-charger mounting position, turbo-charger installation type, turbo-charger group part number, turbo-charger speed, turbo-charger make, turbo-charger model, turbo-charger model housing size, turbo-charger basic part number, and the like.

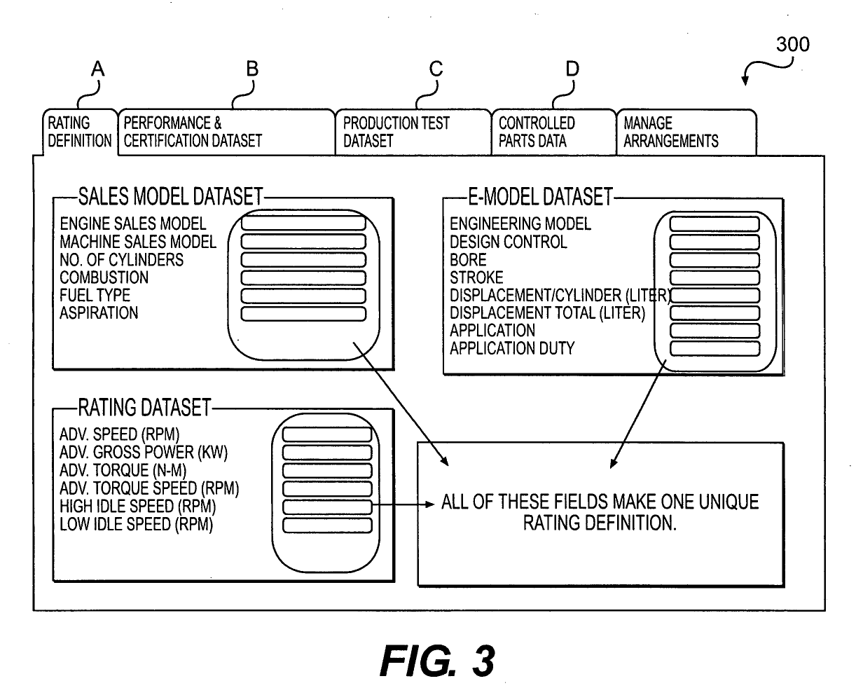

In one exemplary embodiment, as shown in exemplary screenshot 300 of FIG. 3, the rating definition DS_I, including its associated engine sales model dataset DS_A, e-model dataset DS_B, and rating data, may be presented graphically to a user, such as, for example, CDM entity 140. CDM entity 140 may select any of the tabs to view additional associated data, such as, for example, one or more performance datasets DS_D, one or more production test datasets DS_E, one controlled parts dataset DS_G, one or more arrangement numbers DS_H, and one or more sub-entities (e.g., certification datasets, air systems, etc.).

Returning to FIG. 2, once the rating definition DS_I has been generated, CDM computing system 110 may associate one or more arrangement numbers DS_H with the rating definition DS_I. Each of the one or more arrangement numbers DS_H may be an alphanumeric value identifying an engine and its parts. In one exemplary embodiment, each of the one or more arrangement numbers DS_H may serve as an index into database 115, and may thereby also identify each part included in the identified engine. The association of one or more arrangement number DS_H with a rating definition DS_I may provide an indication of a combination of parts (i.e., each arrangement number DS_H) that may be capable of producing a specified amount of power (i.e., rating definition DS_I).

CDM computing system 110 may create and store a “rating snapshot” DS_J of the data to create versioned data. CDM computing system 110 may save the entire rating snapshot DS_J. For example, CDM computing system 110 may save rating snapshot DS_J, which may include, for example, engine sales datasets DS_A, e-model datasets DS_B, certification datasets DS_C, performance datasets DS_D, production test datasets DS_E, air system datasets DS_F, controlled parts datasets DS_G, arrangement numbers DS_H, rating definitions DS_I, certification types DS_K, etc.

Rating snapshot DS_J may be saved and stored in database 115. In some embodiments, CDM computing system 110 may be configured to automatically save the rating snapshot DS_J at predetermined periods of time (e.g., annually, biennially, semiannual, quarterly, monthly, weekly, daily, etc.). Alternatively and/or additionally, the rating definition DS_I may be evaluated and/or re-evaluated based on a predetermined event (e.g., regularly scheduled time intervals, specified or predetermined actions, etc.), and the rating snapshot DS_J may be generated and stored in database 115 upon actuation of the predetermined event. In addition, CDM computing system 110 may create and store rating snapshot DS_J when prompted, requested, instructed, or otherwise directed by an authorized user, such as, for example, one or more of CDM entities 140.

For each arrangement number DS_H associated with a rating definition DS_I, CDM computing system 110 may associate a certification type DS_K (step 210). The certification type DS_K may identify a set of characteristics associated with an emissions certification or regulation. For example, the set of characteristics may include a country or region in which the emissions regulations are applicable (e.g., United States, European Union, State of California, etc.), a regulatory body (e.g., U.S. Environmental Protection Agency, California Air Resources Board, European Environment Agency, etc.), a category (e.g., on-road, highway, marine, etc.), and the like.

For each rating snapshot DS_J and certification type DS_K, CDM computing system 110 may be configured to perform any one or more of the following steps: create certification family (step 215), creating a running change during the life of the certification family (step 220), create a running change during the life of the rating (step 225), create a certification family rollover (step 230), or perform a regulation expiry (step 235).

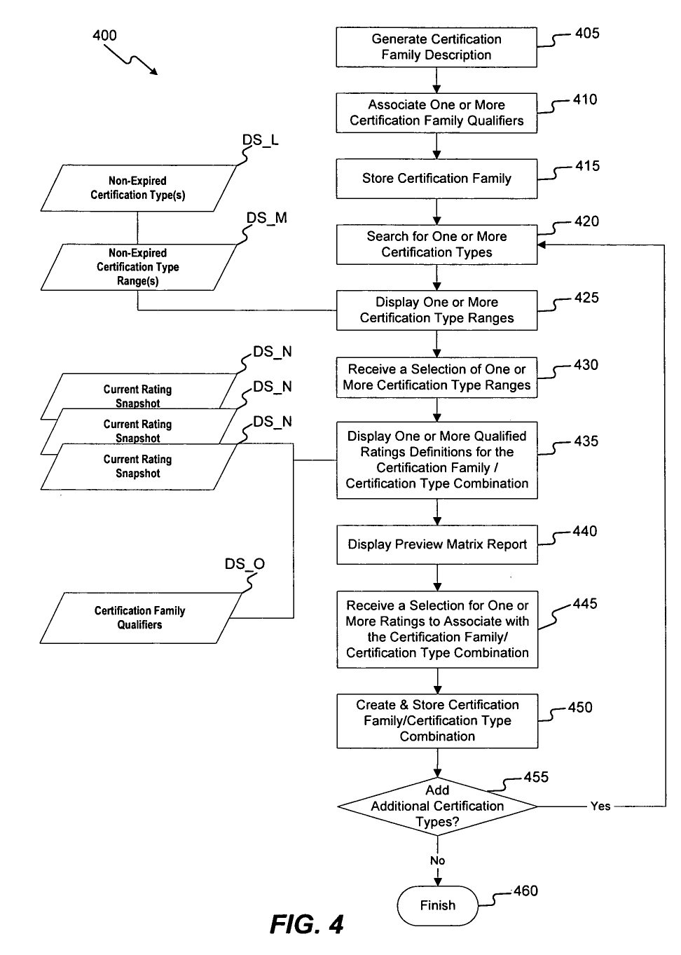

FIG. 4 illustrates a flowchart 400 of an exemplary process for creating a certification family, consistent with certain disclosed embodiments. The process of FIG. 4 may be performed by CDM computing system 110. For example, CDM computing system 110 may execute one or more software programs that perform one or more of the process steps shown in FIG. 4.

CDM computing system 110 may generate a certification family description (step 405). The certification family description may include, for example, a certification family name, a certification family year, a certification family effective date (i.e., the date the certification family becomes effective), a description of the certification family, etc. The certification family description may be received from CDM entity 140 via one or more drop-down boxes, alphanumeric entry fields, radio buttons, check boxes, scrollable lists, menu bars, text fields, and the like.

CDM computing system 110 may associate one or more certification family qualifiers with the certification family description (step 410). The one or more certification family qualifiers may be used to further define the certification family. The one or more certification family qualifiers may include, for example, engine application, model year, displacement per cycle, certified speed, certified power, one or more engine sales models, an aftercooler type, etc. In one exemplary embodiment, CDM computing system 110 may use the one or more certification family qualifiers to locate one or more certification types that may be included in the certification family. The certification family qualifiers may be entered into CDM computing system 110 by CDM entity 140 via one or more drop-down boxes, alphanumeric entry fields, radio buttons, check boxes, scrollable lists, menu bars, text fields, and the like. Once the certification family description and one or more certification family qualifiers have been entered, CDM computing system 110 may store the certification family in database 115 (step 415).

Using one or more selectable parameters, CDM computing system 110 may search database 115 to identify one or more certification types (step 420). The one or more selectable parameters may include, for example, a regulatory country, a regulatory body, a certification category, a regulatory standard, etc.

In response to the selection of one or more parameters, CDM computing system 110 may display one or more certification type ranges which may correspond to the one or more selectable parameters (step 425). The one or more certification type ranges may include one or more range values associated with each certification type, such as, for example, an effective date, an expiry date, and one or more other attributes. Each of the one or more certification type ranges may include data associated with one or more non-expired emissions regulation ranges DS_M. The one or more non-expired emissions regulation ranges DS_M may, in turn, be associated with one or more non-expired emissions regulations or certification types DS_L. In one exemplary embodiment, the non-expired emissions regulations or certification types DS_L may be a subset of the one or more emissions regulations or certification types DS_K, shown in FIG. 2.

CDM computing system 110 may receive a selection of one or more certification type ranges from CDM entity 140 (step 430). The selection of one or more certification type ranges may be received from CDM entity 140 via one or more drop-down boxes, alphanumeric entry fields, radio buttons, check boxes, scrollable lists, menu bars, text fields, and the like. In one exemplary embodiment, the received selection of one or more certification type ranges may be one or more non-expired certification type ranges.

From the received selection of one or more certification type ranges, CDM computing system may display one or more qualified ratings for the certification family/certification type combination (step 435). The one or more qualified ratings for the certification family/certification type combination may use data associated with one or more current rating snapshots DS_N and the certification family qualifiers DS_O, as discussed above in connection with step 410. In one exemplary embodiment, the one or more qualified ratings may be based on arrangement/certification type associations and other data elements. The other data elements may include, for example, certified speed, certified power, displacement per cylinder, model year, engine application, engine sales model, aftercooler type, etc.

CDM entity 140 may cause CDM computing system 110 to display a preview matrix report (step 440). CDM entity 140 may cause CDM computing system 110 to display the preview matrix report by entering one or more parameters identifying the purpose of the preview, and selecting an appropriate action (e.g., create a snapshot, view preview matrix report, etc.). CDM entity 140 may select the appropriate action by using any means known in the art, including, for example, drop-down boxes, alphanumeric entry fields, radio buttons, check boxes, scrollable lists, menu bars, text fields, and the like.

CDM computing system 110 may receive a selection to associate one or more rating definitions with the certification family/certification type combination (step 445). In one exemplary embodiment, CDM computing system 110 may associate one or more rating definitions with the certification family/certification type combination via any means known in the art, including, for example, drop-down boxes, alphanumeric entry fields, radio buttons, check boxes, scrollable lists, menu bars, text fields, and the like. CDM computing system 110 store the data in database 115. CDM computing system 110 may create a certification family/certification type combination, and store the combination in database 115 (step 450).

CDM entity 140 may then determine if additional certification types are to be added to the certification family (step 455). If no additional certification types are to be added to the certification family (step 455, No), CDM computing system 110 may finish (step 460). If additional certification types are to be added to the certification family (step 455, Yes), CDM computing system 110 may return to step 420, and CDM entity 140 may search for one or more certification types to add to the certification family. In one exemplary embodiment, the certification type may be referred to as a regulation.

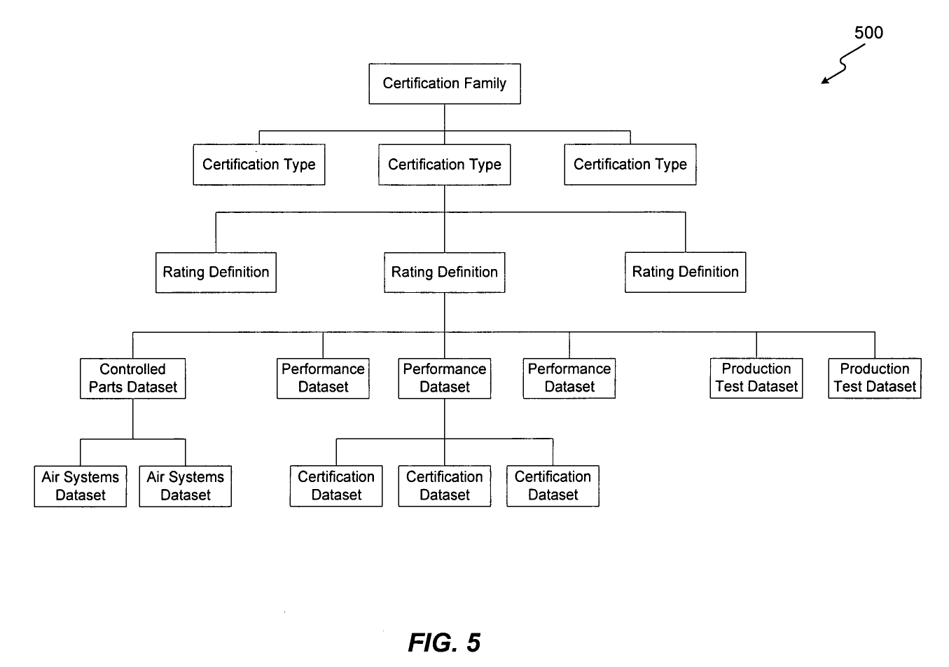

FIG. 5 provides a graphical illustration 500 of exemplary components of a certification family/certification type combination, consistent with certain disclosed embodiments. As discussed above in connection with FIGS. 2 and 4, each certification family may include one or more certification types, and each certification family/certification type combination may include a one or more unique rating definitions. Each of the unique rating definitions may include one or more production test datasets, one controlled parts dataset, and one or more performance datasets. Each of the one or more performance datasets may further include one or more certification datasets. The controlled parts dataset may include one or more air systems datasets.

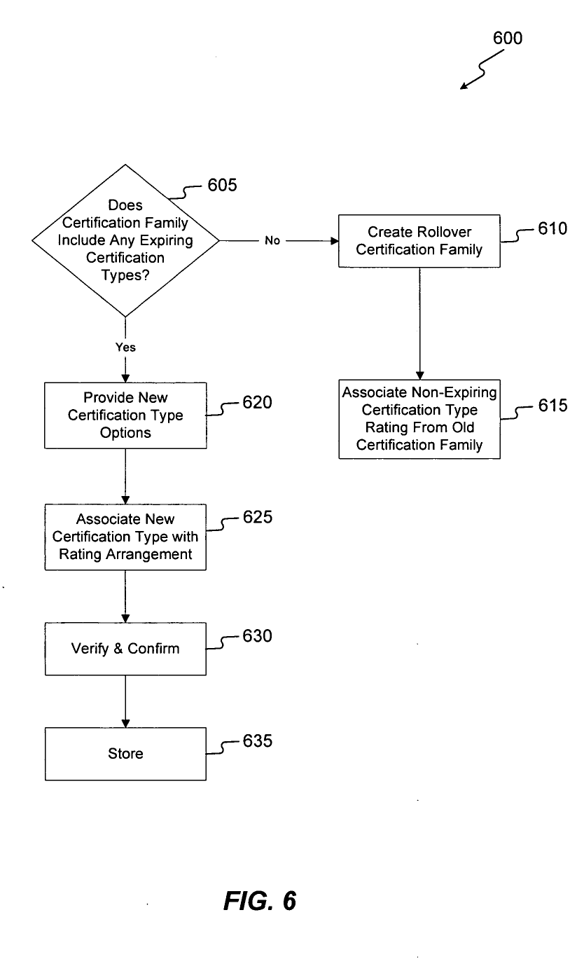

FIG. 6 illustrates a flowchart 600 of an exemplary method for processing end-of-period certification families, consistent with certain disclosed embodiments. The process of FIG. 6 may be performed by CDM computing system 110. For example, CDM computing system 110 may execute one or more software programs that perform one or more of the steps shown in FIG. 6.

CDM computing system 110 may evaluate one or more certification families and determine if the certification family includes any expiring certification types (step 605). CDM computing system 110 may determine if a certification family includes any expiring certification types by evaluating one or more data fields associated with the certification family. For example, CDM computing system 110 may evaluate data stored in database 115 to determine an expiry data associated with one or more certification types and/or their associated data. In one exemplary embodiment, CDM computing system 110 may evaluate a power range and associated expiry data.

If the certification family does not include any expiring certification types (step 605, No), CDM computing system 110 may create a rollover certification family (step 610). In one exemplary embodiment, creating a rollover certification family may include, for example, entering a rollover certification family name, a rollover certification family year, a rollover certification family effective date, a rollover certification family description, etc.

Once the rollover certification family is created, CDM computing system 110 may associate one or more non-expiring certification types from the old certification family to the rollover certification family (step 615). In one exemplary embodiment, CDM computing system 110 may present one or more non-expiring certification types to CDM entity 140, and CDM entity 140 may select one or more of the non-expiring certification types to associate with the rollover certification family. CDM computing system 110 may store the rollover certification family data in database 1115. If a certification family is rolled-over, CDM computing system 110 may prepare and submit one or more certifications and/or other documentation to one or more regulatory entities 150 that establishes that the underlying data for a certification family is unchanged.

If the certification family includes one or more expiring certification types (step 605, Yes), CDM computing system 110 may provide one or more new certification type options for each expiring certification type (step 620). CDM computing system 110 may present one or more expiring certification types and any associated new certification type options to CDM entity 140. CDM entity 140 may select a new certification type option for each expiring certification type. In one exemplary embodiment, CDM computing system 110 may provide one or more certification type options for non-expiring certification types that are no longer applicable to a rating.

CDM computing system 110 may present one or more rating arrangements associated with the expiring certification type, and CDM entity 140 may select a new certification type to associate with one or more rating arrangements of the expiring certification type (step 625). One or more CDM entities 140 may verify and confirm the one or more selected rating arrangements and new certification types (step 630), and CDM computing system 110 may store the confirmed data in database 115.

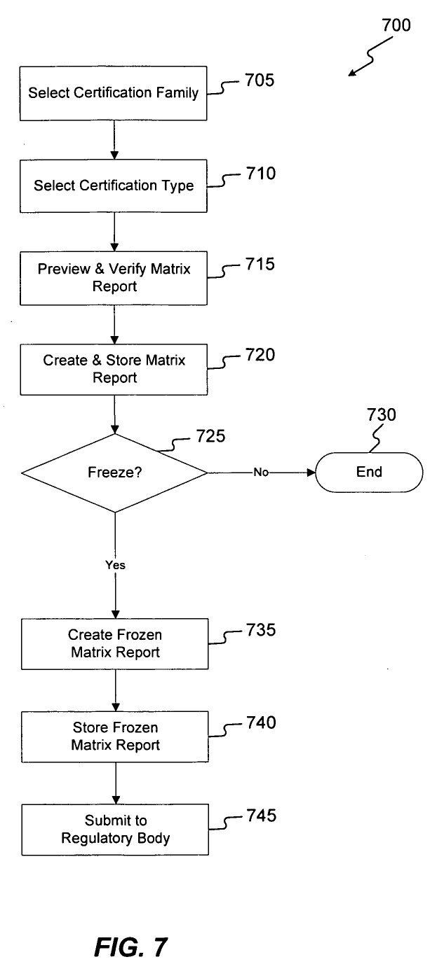

FIG. 7 illustrates a flowchart 700 of an exemplary process for generating matrix reports, consistent with certain disclosed embodiments. The process of FIG. 7 may be performed by CDM computing system 110. For example, CDM computing system 110 may execute one or more software programs that perform one or more of the process steps shown in FIG. 7.

To generate a matrix report, CDM entity 140 may select a certification family (step 705) and then select a certification type (step 710). In one exemplary embodiment, CDM entity 140 may select a certification family and certification type using any means known in the art, including, for example, drop-down boxes, alphanumeric entry fields, radio buttons, check boxes, scrollable lists, menu bars, text fields, and the like. The certification family and certification type may be used in a matrix report and may be submitted to one or more regulatory entities 150 as a certification that the certification family and certification type meet one or more regulatory requirements.

Before creating the matrix report, in some embodiments, CDM entity 140 may preview and verify a matrix report (step 715). CDM entity 140 may preview and verify the matrix report by entering one or more parameters identifying the purpose of the matrix report, and selecting an appropriate action (e.g., create a snapshot, etc.). CDM entity 140 may select the appropriate action by using any means known in the art, including, for example, drop-down boxes, alphanumeric entry fields, radio buttons, check boxes, scrollable lists, menu bars, text fields, and the like.

In response, CDM computing system 110 may create and store the matrix report (step 720). In some embodiments, CDM computing system 110 may store the matrix report in database 115. Matrix reports may be stored in accordance with one or more applicable laws, regulations, processes, and/or procedures. In one exemplary embodiment, test matrix reports may be periodically purged from database 115.

CDM entity 140 may have the option of freezing the matrix report (step 725). If CDM entity 140 decides to freeze the matrix report (step 725, Yes), CDM computing system 110 may create a frozen matrix report (step 735), and may store the frozen matrix report in database 115 (step 740). Frozen matrix reports may be stored in accordance with one or more applicable laws, regulations, processes, and/or procedures. In one exemplary embodiment, frozen matrix reports may be stored permanently. In addition, one or more frozen matrix reports may be submitted to one or more regulatory entities 150 (step 745). If CDM entity 140 decides not to freeze the matrix report (step 725, No), CDM entity 140 may end the process (step 730). In some embodiments, when CDM entity 140 ends the process, CDM entity 140 may return to step 705 and begin the process again.

Matrix reports may be generated when there is any change to the underlying data associated with a certification family/certification type. For example, a matrix report may be generated anytime there is a change to performance datasets, certification datasets, production test datasets, controlled parts dataset, certification families, certification types, regulatory requirements, etc. associated with a certification family/certification type combination. In one exemplary embodiment, any changes to a matrix report after it has been frozen may be highlighted, flagged, or the like. In addition, matrix reports may have version control such that any change to a frozen matrix report may result in a change in the version number.

In one exemplary embodiment, the disclosed embodiments may be fully automated by CDM computing system 110 and may require no user interaction. For example, software processes may receive and store data (e.g., rating definitions, engine sales datasets, e-model datasets, rating datasets, performance datasets, certification datasets, production test datasets, controlled parts dataset, certification families, certification types, regulatory requirements, etc.), and may generate one or more reports. In one exemplary embodiment, the one or more reports may include data for one or more regulatory entities 150, one or more CDM entities 140, or any combination thereof. CDM computing system 110 may generate the one or more reports automatically, on demand, or any combination thereof. For example, CDM computing system 110 may generate the one or more reports on a regular basis, such as, for example, monthly, bimonthly, weekly, biweekly, daily, etc.

### INDUSTRIAL APPLICABILITY

The disclosed embodiments may be implemented with automated processing of any type of certification data. The disclosed embodiments may be capable of facilitating compliance with governmental regulations, and may achieve improved processing associated with regulatory compliance. In particular, the disclosed embodiments may analyze, identify, and/or assess data associated with regulatory compliance, and automatically prepare documents for certification with a variety of regulatory bodies and/or regulatory standards.

For example, the disclosed embodiments may identify one or more expiring certifications, and update certification on the product associated with the one or more expiring certifications. The disclosed embodiments may automatically rollover non-expiring certifications from certification period to certification period. Thus, the disclosed embodiments may offer a way to provide for an efficient and automated way to ensure tracking of compliance with various regulations and laws, and automatically update certification documents for multiple regulatory agencies.

Further, the disclosed embodiments may not be limited to processes between a manufacturer and one or more regulatory bodies. For example, the disclosed embodiments may be applicable to other relationships, such as, auditing of a supplier by a purchaser, auditing of a company and/or industry by an auditing body, etc. In addition, the disclosed embodiments may be used within a business entity. The business entity may include divisions, groups, etc. that interact as sub-entities for the business entity. The sub-entities may act as a user of a good supplied by a supplier sub-entity within the same business entity, such as a manufacturing business with supply division, production line division, etc.

It will be apparent to those skilled in the art that various modifications and variations can be made in the automated processing of certification data management. It is intended that the specification and examples be considered as exemplary only, with a true scope of the disclosed embodiments being indicated by the following claims and their equivalents.

What is claimed is:

1. A method for processing certification data, comprising:
determining a rating definition associated with an engine configuration;
associating an arrangement number with the rating definition;
associating a certification type with the arrangement number; and
associating a certification dataset, created by recording emissions test results of one or more emissions data parameters, with the rating definition to generate a certification family, wherein the one or more emissions data parameters are included in at least one of an emissions law or an emissions regulation.

2. The method of claim 1, further including:
associating one or more certification types with the certification family;
generating a certification family/certification type combination; and
adding one or more qualified ratings to the certification family/certification type combination.

3. The method of claim 2, further including:
determining if the certification family/certification type combination includes one or more expiring certification types.

4. The method of claim 3, further including:
generating, when the certification family/certification type combination does not include one or more expiring certification types, a rollover certification family, wherein the rollover certification family includes the certification family/certification type combination and the one or more qualified ratings.

5. The method of claim 3, further including:
evaluating, when the certification family/certification type combination includes one or more expiring certification types, the expiring data;
associating one or more non-expiring certification types to arrangements in the certification family/certification type combination which includes the one or more expiring certification types;
creating, when a certification family/certification type combination does not exist, a new certification family/certification type combination; and
adding, to one of the new certification family/certification type combination or an existing certification family/certification type combination, the one or more non-expiring certification types.

6. The method of claim 2, further including:
generating one or more reports, wherein the one or more reports include at least one certification associated with one or more regulatory bodies; and
providing the one or more reports to the one or more regulatory bodies.

7. A computer-readable medium including instructions for performing a method, when executed by a processor, for processing certification data, the method comprising:
determining a rating definition associated with an engine configuration;
associating an arrangement number with the rating definition;
associating a certification type with the arrangement number; and
associating a certification dataset, created by recording emissions test results of one or more emissions data parameters, with the rating definition to generate a certification family, wherein the one or more emissions data parameters are included in at least one of an emissions law or an emissions regulation.

8. The computer-readable medium of claim 7, the method further including:
associating one or more certification types with the certification family;
generating a certification family/certification type combination; and
adding one or more qualified ratings to the certification family/certification type combination.

9. The computer-readable medium of claim 8, the method further including:
determining if the certification family/certification type combination includes one or more expiring certification types.

10. The computer-readable medium of claim 9, the method further including:
generating, when the certification family/certification type combination does not include one or more expiring certification types, a rollover certification family, wherein the rollover certification family includes the certification family/certification type combination and the one or more qualified ratings.

11. The computer-readable medium of claim 9, the method further including:
evaluating, when the certification family/certification type combination includes one or more expiring certification types, the expiring data;
associating one or more non-expiring certification types to all arrangements in the certification family/certification type combination which includes the one or more expiring certification types;
creating, when a certification family/certification type combination does not exist, a new certification family/certification type combination; and
adding, to one of the new certification family/certification type combination or an existing certification family/certification type combination, the one or more non-expiring certification types.

12. The computer readable medium of claim 8, the method further including:
generating one or more reports, wherein the one or more reports include at least one certification associated with one or more regulatory bodies; and
providing the one or more reports to the one or more regulatory bodies.

13. A system for processing certification data, comprising:
at least one memory storing data and instructions; and
at least one processor configured to access the memory and execute the instructions to:
determine a rating definition associated with an engine configuration;
associate an arrangement number with the rating definition;
associate a certification type with the arrangement number;
associate a certification dataset, created by recording emissions test results of one or more emissions data parameters, with the rating definition to generate a certification family;
associate one or more certification types with the certification family;
generate a certification family/certification type combination;
add one or more qualified ratings to the certification family/certification type combination;
determine if the certification family/certification type combination includes one or more expiring certification types;
generate, when the certification family/certification type combination does not include one or more expiring certification types, a rollover certification family, wherein the rollover certification family includes the certification family/certification type combination and the one or more qualified ratings;
associate one or more non-expiring certification types to all arrangements in the certification family/certification type combination which includes the one or more expiring certification types;
create, when a certification family/certification type combination does not exist, a new certification family/certification type combination;
add, to one of the new certification family/certification type combination or an existing certification family/certification type combination, the one or more non-expiring certification types;
generate one or more reports, wherein the one or more reports include at least one certification associated with one or more regulatory bodies; and
provide the one or more reports to the one or more regulatory bodies.

14. The system of claim 13, wherein the one or more emissions data parameters are included in one or more emissions laws or emissions regulations.

15. A method for processing certification data, comprising:
generating a certification family;
associating one or more certification types with the certification family to generate a certification family/certification type combination;
adding one or more qualified ratings to the certification family/certification type combination;
determining if the certification family/certification type combination includes one or more expiring certification types; and
generating, when the certification family/certification type combination does not include one or more expiring certification types, a rollover certification family, wherein the rollover certification family includes the certification family/certification type combination and associated rating definitions.

16. The method of claim 15, further including:
associating a non-expiring certification type to all arrangements in the certification family/certification type combination which includes the one or more expiring certification types;
creating, when a certification family/certification type combination does not exist, a new certification family/certification type combination; and
adding, to one of the new certification family/certification type combination or an existing certification family/certification type combination, the one or more non-expiring certification types.

17. The method of claim 15, further including:
generating one or more reports, wherein the one or more reports include at least one certification associated with one or more regulatory bodies; and
providing the one or more reports to the one or more regulatory bodies.

18. A computer-readable medium including instructions for performing a method, when executed by a processor, for processing certification data, the method comprising:
generating a certification family;
associating one or more certification types with the certification family to generate a certification family/certification type combination;
adding one or more qualified ratings to the certification family/certification type combination;
determining if the certification family/certification type combination includes one or more expiring certification types; and
generating, when the certification family/certification type combination does not include one or more expiring certification types, a rollover certification family, wherein the rollover certification family includes the certification family/certification type combination and associated rating definitions.

19. The computer-readable medium of claim 18, the method further including:
associating a non-expiring certification type to all arrangements in the certification family/certification type combination which includes the one or more expiring certification types;
creating, when a certification family/certification type combination does not exist, a new certification family/certification type combination; and
adding, to one of the new certification family/certification type combination or an existing certification family/certification type combination, the one or more non-expiring certification types.

20. The computer-readable medium of claim 18, the method further including:
generating one or more reports, wherein the one or more reports include at least one certification associated with one or more regulatory bodies; and
providing the one or more reports to the one or more regulatory bodies.

21. A system for processing certification data, comprising:
at least one memory storing data and instructions; and
at least one processor configured to access the memory and execute the instructions to:
generate a certification family;
associate one or more certification types with the certification family to generate a certification family/certification type combination;
add one or more qualified ratings to the certification family/certification type combination;
determine if the certification family/certification type combination includes one or more expiring certification types; and
generate, when the certification family/certification type combination does not include one or more expiring certification types, a rollover certification family, wherein the rollover certification family includes the certification family/certification type combination and associated rating definitions.

22. The system of claim 21, wherein the processor is further configured to:
associate a non-expiring certification type to all arrangements in the certification family/certification type combination which includes the one or more expiring certification types;
create, when a certification family/certification type combination does not exist, a new certification family/certification type combination; and
add, to one of the new certification family/certification type combination or an existing certification family/certification type combination, the one or more non-expiring certification types.

23. The system of claim 21, wherein the processor is further configured to:
generate one or more reports, wherein the one or more reports include at least one certification associated with one or more regulatory bodies; and
provide the one or more reports to the one or more regulatory bodies.
